(19) United States
(12) Patent Application Publication
(10) Pub. No.: US 2003/0074339 A1
(43) Pub. Date: Apr. 17, 2003

(54) Formulas of intelligent decision service and the process of using the computerized formulas

(76) Inventor: Gewei Ye, Alpharetta, GA (US)

Correspondence Address: YE, GEWEI, 100 HILLMAN CT., ALPHARETTA, GA, 30022, US

(21) Appl. No.: 09/852,337

(22) Filed: May 10, 2001

(51) Int. Cl. G06F 15/18

(52) U.S. Cl. 706/16

(57) ABSTRACT

The invention pertains to the following three aspects: (1) the commercial use of the computerized formulas in any forms of business development and practice. The main field of the business practice is the intelligent decision (broker) service via wireless device, Internet, and desktop or handheld devices. The intelligent decision broker service helps users make sound decisions based on more solid theoretical foundation; (2) any economic and statistical computer applications using the computerized formulas with the decision likelihood theory. The potential of using the formulas and the associated processes is unlimited because everyone needs to make discrete choices everyday. The formulas can be used in financial, political, educational areas alike; (3) the core computer application with the formulas embedded, the judgment prediction system, is available for commercial elaboration and integration. It may be the decision-making modules for robots, since it can provide human-like measurable indices for choice alternatives.

### COPYRIGHT STATEMENT

This invention contains computerized formulas of intelligent decision (broker) service, and the process of creating and using the formulas. The invention is owned by Gewei Ye. He can be contacted by airmail at 100 Hillman Court, Alpharetta, Ga. 300Z2, or by email at gye@ace.cs.ohiou.edu.

### BACKGROUND OF INVENTION

The invention pertains to the field of endeavor of the following: commercial use of the computerized formulas and processes in intelligent decision services in any forms, such as wireless device, Internet, and desktop or handheld devices alike; computer applications using the formulas of the mathematical model with the decision likelihood theory, such as the decision-making modules of robots.

Daniel McFadden, the Nobel Prize laureate, suggested a decision process framework for discrete choice behavior in 1999 based on his Nobel Prize related work (reference article: McFadden, D. (1999). Rationality for economists?, Journal of Risk and Uncertainty, 19, 73-105). The advantage of the framework over traditional economic models or analysis for discrete choice behavior is that it contains human psychological factors in economic and financial modeling and analysis. While the traditional economic analysis considers only economic indices. However, McFadden didn't propose a mathematical model for the decision process in the framework. Also there is no other computer applications available at present for commercial use that has implemented the mathematical model that the inventor proposed.

### SUMMARY OF INVENTION

This invention is part of Gewei Ye's doctorate dissertation and his recent research. The invention proposes new theoretical and practical approaches to explain and predict human choice behavior. It contains a multinomial decision process model and the computer programs implementing the model. The mathematical model elaborated the decision process of Daniel McFadden's framework. See FIG. 1 for the model. The computer programs use the formulas provided by the model to compute the decision likelihood values. Decision makers should choose the alternatives with the bigger or the biggest likelihood value(s). This is the decision likelihood theory. Decision likelihood refers to the chance of making positive decision(s) for the alternatives.

The objective of the patent is to protect the computerized formulas and the multinomial decision process model from being misused in commercial world. The commercial and financial potential of the invention is unlimited, since choice behavior happens to everyone everyday. In the meanwhile, helping people make sound choices must use the sound theoretical foundation. One of the commercial applications of the invention can be intelligent decision broker (support) service. Intelligent decision broker service refers to the automated and computerized service that assists users to make sound decisions via desktop or handheld device, Internet, or wireless device. An example of the service is to provide decision assistance for financial or investment choices via wireless cellular phones. The patent also protects the processes of using the mathematical model and the computerized formulas in any other form.

### BRIEF DESCRIPTION OF DRAWINGS

FIG. 1: the multinomial decision process model for the process element in McFadden's decision process framework. It describes how the information is processed consciously and unconsciously by human mind and how the decision likelihood is created. The definitions of the symbols in the figure are as follows:

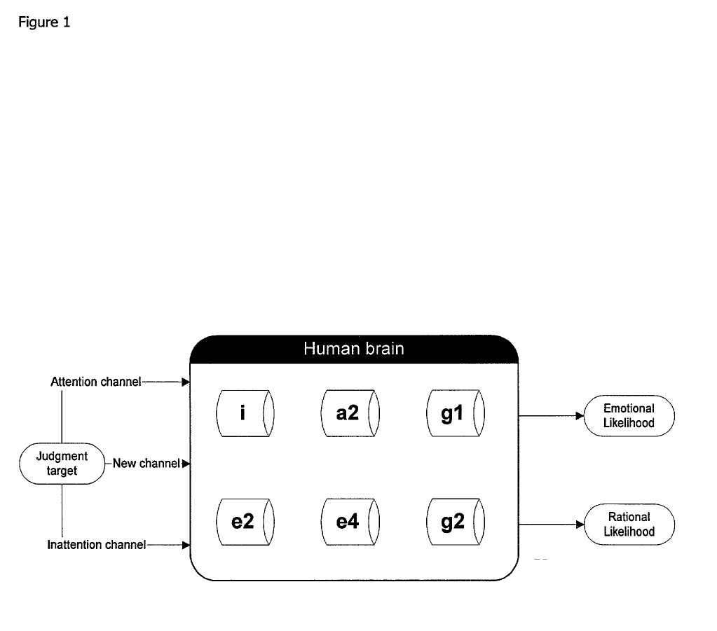

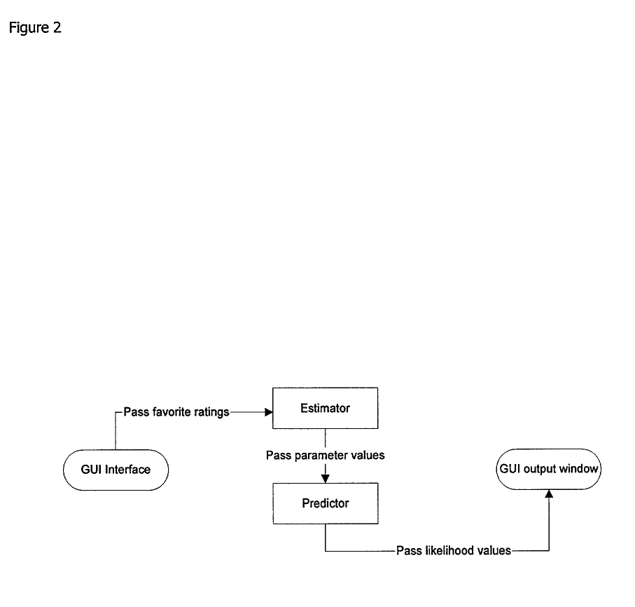

•i₁: the probability of invoking unconscious memory given the item is attended or unattended. It also represents the automatic component of the process element in this case. •e₂: the probability of invoking conscious memory given unconscious memory is not invoked and the item is attended. It also represents the rational component of the process element in this case. •e₄: the probability of invoking conscious memory given unconscious memory is not invoked and the item is not attended. It also represents the rational component of the process element in this case. •a₂: the probability of liking given unconscious memory is not invoked. It also represents the emotional component of the process element in this case. •g₁: the probability of guessing given liking. It also represents the guessing component of the process element in this case. •g₂: the probability of guessing given no liking. It also represents the guessing component of the process element in this case.

FIG. 2: System components of the computer application named as Judgment Prediction system. The computerized formulas are embedded in the application.

### DETAILED DESCRIPTION

[Process of Making the Computer Programs]

The computer programs, at its current form, are part of a computer application labeled as the judgment prediction system UPS). The application contains four components: GUI interface, estimator, predictor, and output interface. See FIG. 2 for the details of the JPS system. It is authored with Java language (JDK1.3) with a relational database management system in the backend. The following is the process of making the computer application.

1. In the predictor component, the formulas of the multinomial decision process model are computerized. With the availability of the six model parameter values, the output decision likelihood values are also computed. The formulas of the predictor component are embedded in a computer program named LMPredictor.java which is listed in the section of program listing deposit. The formulas are shown as follows:

| | R&L | R&˜L | ˜R&L | ˜R&˜L |
|---|---|---|---|---|
| Attention | i+(1-i) e2 a2 | (1-i) e2 (1- | (1-i)(1- e2) | (1-i)(1- e2) |
| information | +(1-i)(1-e2)a2 | a2)+(1-i)(1- | a2 (1-g1) | (1-a2)(1-g2) |
| channel | g1 | e2)(1-a2)g2 | | |
| Inattention | i+(1-i) e4 a2 | (1-i) e4 (1- | (1-i)(1- e4) | (1-i)(1- e4) |
| information | +(1-i)(1- e4) a2 | a2)+(1-i)(1- | a2 (1- g1) | (1-a2)(1- g2) |
| channel | g1 | e4)(1-a2) g2 | | |
| New | a2 g1 | (1-a2) g2 | a2 (1-g1) | (1-a2)(1-g2) |
| information | | | | |
| channel | | | | |

2. In the estimator component, the values of the six model parameters are estimated based on the evaluation ratings of the information through three channels, namely, attention, inattention, and new channels. The estimator formulas are embedded in the computer program named EstimateParms.java, which is listed in the section of program listing deposit.

3. After the predictor and estimator components are built, the CUI interface is created to accept user evaluation ratings. It passes the rating information to the estimator. The GUI interface-is written with Java Swing (JDK1.3).

4. The Output interface displays the decision likelihood values and user evaluation ratings. These values are stored in a relational database management system along with the intermediate results.

[Process of Using the Computer Programs]

The computer programs of the judgment prediction system are component-based and reusable source code. They are ready for integration and elaboration for commercial use. The processes of using the computer programs are as follows:

In the field of intelligent decision services, the computer programs can compute the decision likelihood of choice alternatives and suggest the preferred choices based on the likelihood values. According to the nature of the choice alternatives, the computer programs can be used in the areas of financial, political, educational, or other choices. For example, in the field of financial intelligent decision services, the computer programs can compute the decision likelihood for financial choice alternatives such as stocks, commercials, houses alike.

According to the media and channels used to access the intelligent decision service provided by the computer programs, the programs can be built in desktop or handheld device, in Internet service applications, or in wireless service applications.

Desktop or laptop PCs or handheld devices. The computer programs can be built in an application used in desktop or laptop PCs. Users can installed the software in a personal computer and use it to compute decision likelihood as to help make decisions. The programs can also be built into a handheld device which can be sold as a commercial product. Customers can buy the device and use it in the cases of making a hard decision.

Internet service. The computer programs can be built in an Internet service application which provides decision broker services to its customers. The customers can use a wired browser to access the service.

Wireless Internet service. The computer programs can be built in a wireless Internet service application which provides intelligent decision (broker) services. The customers can use a wireless device, for example, the cellular phones, to access the service. A web demonstration is available at http://ace.cs.ohiou.edu/˜gye/jpsdemo/jpsdemo.html.

Besides the application in human decision making in commercial world, the computerized formulas can be used in designing machine decision making, such as building the thinking and decision-making modules for robots. The decision-making modules can thus represent human decision-making process, with emotion, conscious and unconscious information processes, guessing, etc.

[Process of Making the Model]

The multinomial decision model is a mathematical model that was developed using laboratory experiments with human decision makers. The following is the process:

1. Before the experiments, an original multinomial model are proposed to speculate the parameters of the mechanisms in human brain that may be involved in processing the alternatives' information.

2. During experiments, human decision makers are confronted with several tasks after being presented with unfamiliar stimuli. The presented stimuli are of two types. One type of the stimuli requires decision makers' attention, while the other type does not. In these tasks, a mixture of the presented stimuli of the two types and new stimuli is presented followed by choice tasks. Some of the tasks ask the decision makers to choose Yes or No about whether they have seen the stimuli. Some other tasks ask the decision makers to choose Yes or No about whether they like the stimuli. Their responses are collected to build the multinomial decision process model. The procedure of the experiments is automated and the response data are collected with the computer programs written by the inventor. Decision makers completed the experiments with desktop computers having the computer programs installed.

3. After the response data are collected, a statistical program, the multinomial binary tree program developed by Hu, XiangGen in 1991 at University of California (Irvine), is used to fit the original model with the data. After several modifications of the original model, a final model is obtained with a perfect fit with the data. The final model is further tested with subsets of the data to make sure it is replicable. See Gewei Ye's doctorate dissertation for more detailed process of making the mathematical model.

Program Listing Deposit

[Beginning of Program]
[Computer program #1: LMPredictor.java
/**
* @author Dr. Gewei Ye
* @version 1.00 July 2000, initial
* @version 1.01 August 2000, added average likelihood, corrected UAS equations
*/
import java.io.*;
import java.text.*;
import sharedValues;
import EstimateParms;
/**
* Take input for the six parameters from sharedValues done with EstimateParms;
* Compute intermediate variables;
* Integrate to result of two output: liking and recognition judgments.
*/
public class LMPredictor
{

double i=0.00;
double e2=0.00;
double e4=0.00;
double a2=0.00;
double g1=0.00;
double g2=0.00;
public double compute_as_r_l( )
{

double as_r_nl=0.00;
as_r_l = i+(1−i)*e2*a2 + (1−i)*(1− e2)*a2*g1;
return as_r_l;

} //end of compute_as_r_l
public double compute_as_r_nl( )
{

double as_r_nl=0.00;
as_r_nl = (1−i)*e2*(1−a2)+(1−i)*(1−e2)*(1−a2)*g2;
return as_r_nl;

} //end of compute_as_r_nl( )
public double compute_as_{—nr}_l( )
{

double as_nr_l=0.00;
as_nr_l = (1−i)*(1− e2)*a2*(1−g1);
return as_nr_l;

} //end of compute_as_nr_l
public double compute_as_nr_nl( )
{

double as_nr_nl=0.00;
as_nr_nl = (1−i)*(1−e2)*(1−a2)*(1−g2);
return as_nr_nl;

} //end of compute_as_nr_nl
public double compute_uas_r_l( )
{

double uas_r_l=0.00;
uas_r_l = i+(1−i)*e4*a2 +(1−i)*(1−e4)*a2*g1;
return uas_r_l;

} //end of compute_as_r_l
public double compute_uas_r_nl( )
{

double uas_r_nl=0.00;
uas_r_nl = (1−i)*e4*(1−a2)+(1−i)*(1−e4)*(1−a2)*g2;
return uas_r_nl;

} //end of compute_as_r_nl
public double compute_uas_nr_l( )
{

double uas_nr_l=0.00;
uas_nr_l = (1−i)*(1−e4)*a2*(1−g1) ;
return uas_nr_l;

} //end of compute_as_nr_l
public double compute_uas_nr_nl( )
{

double uas_nr_nl=0.00;
uas_nr_nl = (1−i)*(1−e4)*(1−a2)*(1−g2);
return uas_nr_nl;

} //end of compute_as_nr_l
public double compute_ns_r_l( )
{

double ns_r_l=0.00;
ns_r_l = a2*g1;
return ns_r_l;

} //end of compute_ns_r_l
public double compute_ns_r_nl( )
{

double ns_r_nl=0.00;
ns_r_nl = (1−a2)*g2;
return ns_r_nl;

} //end of compute_ns_r_nl
public double compute_ns_nr_l( )
{

double ns_nr_l=0.00;
ns_nr_l = a2*(1− g1);
return ns_nr_l;

} //end of compute_ns_nr_l
public double compute_ns_nr_nl( )
{

double ns_nr_nl=0.00;
ns_nr_nl = (1−a2)*(1−g2);
return ns_nr_nl;

} //end of compute_ns_nr_nl
public double stringToDouble*String str)
{

double ret=0.00;
try{
DecimalFormat df=new DecimalFormat( );

Number n = df.parse(str); // string converted to double
ret = n.doubleValue( );

}
catch(ParseException e)
{

System.out.println(“String parse error. \n”);

}
return ret;

} //end of StringToDouble( )
public void compute_all( )
{
//values of 12 cells
System.out.println(“\nAttention channel\n”+

“as_r_l:“+compute_as_r_l( )+“\n”+
“as_r_nl:”+compute_as_r_nl( )+“\n”+
“as_nr_l:”+compute_as_nr_l( )+“\n”+
“as_nr_nl:”+compute_as_nr_nl( )+“\n\n”+
“Unattention channel\n”+
“uas_r_l:”compute_uas_r_l( )+“\n”+
“uas_r_nl:”+compute_uas_r_nl( )+“\n”+
“uas_nr_l:”+compute_uas_nr_l( )+“\n”+
“uas_nr_nl:”+compute_uas_nr_nl( )+“\n\n”+
“New channel\n”+
“ns_r_l:”+compute_ns_r_l( )+“\n”+
“ns_r_nl:”+compute_ns_r_nl( )+“\n”+
“ns_nr_l:”+compute_ns_nr_l( )+“\n”+
“ns_nr_nl:”+compute_ns_nr_nl( )+“\n\n”);

//values of 4 cells
double r_l = compute_as_r_l( ) + compute_uas_r_l( ) + compute_ns_r_l( );
double r_nl = compute_as_r_nl( ) + compute_uas_r_nl( ) + compute_ns_r_nl( );
double nr_l = compute_as_nr_l( ) + compute_uas_nr_l( ) + compute_ns_nr_l( );
double nr_nl = compute_as_nr_nl( ) + compute_uas_nr_nl( ) + compute_ns_nr_nl( );
System.out.println(“Average (regardless of channels) \n”);
System.out.println(“r_l:”+r_l/3+“\n”+

“r_nl:”+r_nl/3+“\n”+
“nr_l:”+nr_l/3+“\n”+
“nr_nl:”+nr_nl/3+“\n”+“\n”);

sharedValues estVal = new sharedValues( );
String tablename1 = “ATTENTIONCELLVALUE”;
String mysessionid = estVal.sessionId;
try {

loadData ld = new loadData(tablename1,

compute_as_r_l( ),
compute_as_r_nl( ),
compute_as_nr_l( ),
compute_as_nr_nl( ),
mysessionid);

}

catch (Exception e)

{
System.out.println(“load Data failed...”);
}

String tablename2 = “INATTENTIONCELLVALUE”;
try {

loadData ld = new loadData(tablename2,

compute_uas_r_l( ),
compute_uas_r_nl( ),
compute_uas_nr_l( ),
compute_uas_nr_nl( ),
mysessionid);

}

catch (Exception e)

{
System.out.println(“load Data failed...”);
}

String tablename3 = “NEWCELLVALUE”;
try {

loadData ld = new loadData(tablename3,

compute_ns_r_l( ),
compute_ns_r_nl( ),
compute_ns_nr_l( ),
compute_ns_nr_nl( ),
mysessionid);

}

catch (Exception e)

{
System.out.println(“load Data failed...”);
}

String tablename4 = “AVERAGECELLVALUE”;
try }

loadData ld = new loadData(tablename4,

r_l/3,
r_nl/3,
nr_l/3,
nr_nl/3,
mysessionid);

}

catch (Exception e)

{
System.out.println(“load Data failed...”);
}

double l=r_l/3 + nr_l/3;
double r=r_l/3 + r_nl/3;
String tablename5 = “LIKELIHOOD”;
try {

loadData ld = new loadData(tablename5,

mysessionid,
l,
r);

}
catch (Exception e)
{
System.out.println(“load Data failed...”);
}

estVal.retAvgLiking = 1;
estVal.retAvgRecog = r;
System.out.println(“Overall liking prediction (likelihood):“+ l +

“\nOverall recognition prediction (likelihood):” + r +“\n\n”);

} // end of compute_all( )
public void initConnectGUI( )
{
String[ ] greeting = new String[3];
greeting[0]=“\nCompute the Prediction Likelihood for Liking and Remembering
Decision Making”;
greeting[1] = “\t\t\t\tCopyright protected”;
greeting[2] = “\t\t\t\tJuly 2000\n”;
int num;
int para_no;
double n31=0.00;
double ratioNew = 0.00;
for (num = 0; num < greeting.length; num++)

System.out.println(greeting[num]);

//LMPredictor a_predictor = new LMPredictor( );
//BufferedReader in = new BufferedReader(new InputStreamReader(System.in));
sharedValues estVal = new sharedValues( );
try {
EstimateParms est = new EstmateParms( );
est.Estimate( );
i = est.i;
a2 = est.a2;
e2 = est.e2;
e4 = est.e4;
g1 = est.g1;
g2 = est.g2;
this.compute_all( );
} //end of try
catch(Exception e)
{
System.out.println(“Parameter passing error\n”);
}

} //end of main
} //end of LMPredictor class
Computer program #2: EstimateParms.java
import java.io.*;
import java.text.*;
import sharedValues;
import LMPredictor;

| | |
|---|---|
| /** | |
| * | Accept input of the favorite ratings on the scroll bars |
| * | from the initial window through sharedValues |
| * | Estimate the input values for the six parameters to the |
| * | computing functions of the LMPredictor |
| * | @author Dr. Gewei Ye |
| */ | |

public class EstimateParms
{

static double i=0.00;
static double a2=0.00;
static double e2=0.00;
static double e4=0.00;
static double g1=0.00;
static double g2=0.00;
double n31=0.00;
double ratioNew = 0.00;
double red = 0.00;
double green = 0.00;
double blue = 0.00;

public void Estimate( )
{
sharedValues estVal = new sharedValues( );
//Favorite rating
//redValue = n11 + n13
//greenValue = n21 + n23
//blueValue = n31 + n33
System.out.println(“redValue: ”+estVal.redValue);
System.out.println(“green Value: ”+estVal.greenValue);
System.out.println(“blueValue: ”+estVal.blueValue);
red = estVal.redValue;
green = est.Val.greenValue;
blue = estVal.blueValue;
i = (red−blue)/(100−blue);
System.out.println(“i: \n”+i);
a2 = blue/100;
System.out.println(“a2: \n”+a2);
e2 = 1 − (100 − red)/100 * (l−i)*(l-31 a2);
System.out.println(“e2: \n”+e2);
e4 = 1 − (100 − green)/100 * (1−i)*(1−a2);
System.out.println(“e4: \n”+e4);
ratioNew = blue/(100 − blue);
n31 = blue*ratioNew/(1+ratioNew);
g1 = n31/blue;
System.out.println(“g1: \n”+g1);
g2 = n31/100 * (1−a2);
System.out.println(“g2: \n”+g2);
//insert into MODELPARMVALUES table
String tablename = “MODELPARMVALUES”;
String mysessionid = null;
try{

getSessionId myObjSessionId = new getSessionId(tablename);
System.out.println(“in getSessionID, mysessionid is

“+myObjSessionId.retSessionId);

mysessionid = myObjSessionId.retSessionId;
}

catch (Exception e)

{
System.out.println(“Error in getSessionId( ). ”);
}

estVal.sessionId = mysessionid;

try {

loadData ld = new loadData(tablename,

mysessionid,
i,
a2,
e2,
e4,
g1,
g2);

}
catch (Exception e)

{
System.out.println(“load Data failed...”);
}

}
public static void main(String[ ] args)
{

EstimateParms est = new EstimateParms( );
est.Estimate( );

}

}
}
[End of Program]

1. What I claim as my invention is all the formulas used in the computer programs in the section of program listing deposit. These formulas contain not only those from the multinomial decision model, but also the additional formulas used in the computer programs. The process of inventing the formulas of the model and the process of making the components of the computer programs, as well as the processes of potentially using the computer programs and the model in commercial world, are also part of the invention. The formulas and the processes of using the formulas in any forms constitute the scope of the protection of the patent.
